(19) United States
(12) Patent Application Publication
(10) Pub. No.: US 2007/0231704 A1
(43) Pub. Date: Oct. 4, 2007

(54) Lithium ion conductive solid electrolyte and production process thereof

(75) Inventor: Yasushi Inda, Sagamihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OHARA INC., Sagamihara-shi (JP)

(21) Appl. No.: 11/727,489

(22) Filed: Mar. 27, 2007

(30) Foreign Application Priority Data
Mar. 30, 2006 (JP) 2006-095736

(51) Int. Cl. H01M 10/36; C04B 35/64

(52) U.S. Cl. 429/322; 429/320; 264/618

(57) ABSTRACT

A lithium ion conductive solid electrolyte formed by sintering a molding product containing an inorganic powder and having a porosity of 10 vol % or less, which is obtained by preparing a molding product comprising an inorganic powder as a main ingredient and sintering the molding product after pressing and/or sintering the same while pressing, the lithium ion conductive solid electrolyte providing a solid electrolyte having high battery capacity without using a liquid electrolyte, usable stably for a long time and simple and convenient in manufacture and handling also in industrial manufacture in the application use of secondary lithium ion battery or primary lithium battery, a solid electrolyte having good charge/discharge cyclic characteristic in the application use of the secondary lithium ion battery a solid electrolyte with less water permeation and being safe when used for lithium metal-air battery in the application use of primary lithium battery, a manufacturing method of the solid electrolyte, and a secondary lithium ion battery and a primary lithium battery using the solid electrolyte.

### BACKGROUND OF THE INVENTION

1. Field of the Invention

The present invention concerns a solid electrolyte suitable mainly to an all solid secondary lithium ion battery and a primary lithium battery, and a production process thereof, as well as a secondary lithium ion battery and a primary lithium battery having the solid electrolyte.

2. Description of the Related Art

In recent years, all solid batteries using inorganic solid electrolytes for electrolytes of secondary lithium ion batteries have been proposed. Since the all solid batteries use no combustible organic solvents such as liquid electrolytes, they are free from the worry of liquid leakage or explosion and excellent in safety. However, in the case of the all solid state battery, since the transfer resistance of lithium ions is high compared with that in the battery using the liquid electrolyte, it is difficult to obtain a battery of high power.

As described above, the secondary lithium ion batteries or the primary lithium batteries having the solid electrolytes involve a problem that they cannot be put to practical use because the lithium ion conductivity of the solid electrolyte is low. For example, it has been reported of assembling a secondary lithium ion battery by using an all solid state electrolyte prepared by pelleting a solid inorganic material such as sulfide glass by pressing as disclosed, for example, JP-A-2004-348972, but since the lithium ion conductivity is not sufficiently high, this secondary battery has not yet been put to practical use.

Further, in a case of a primary lithium battery comprising a lithium metal electrode and an air electrode, when a water content formed at the air electrode permeates a solid electrolyte as a separator to reach a lithium electrode, it causes explosion to result in danger, so that it requires a solid electrolyte which is dense and has less water permeability, but no lithium ion conductive solid electrolyte having a sufficient water impermeability has been present.

For example, while sintered β-alumina material has been disclosed as a solid electrolyte for use in sodium-sulfur battery, for example, in JP-A-5-162114 and JP-A-8-337464, no solid electrolyte of a desired lithium ion conductivity can be obtained when the production processes disclosed in the literatures are applied as they are due to the difference of the adequacy of the sinterability, the crystalline structure and the solid phase reaction of the starting powder.

### SUMMARY OF THE INVENTION

For solving the problems described above, the present invention intends to provide a solid electrolyte having high battery capacity without using liquid electrolyte usable stably for a long time and simple and convenient for the manufacture and handling also in industrial production for the use of secondary lithium ion batteries and primary lithium batteries.

Further, the invention intends to provide a solid electrolyte of good charge/discharge cyclic characteristic in the application use of the secondary lithium ion battery.

Further, the invention intends to provide a solid electrolyte with less water permeability and safety also in the use of lithium metal-air battery for the use of primary lithium batteries.

Furthermore, the invention intends to provide a production process for the solid electrolyte described above and a secondary lithium ion battery and a primary lithium battery using the solid electrolyte described above.

The present inventors have made detailed experiments on various electrolytes for use in a secondary lithium ion battery and a primary lithium battery and, as a result, have found that a sintered material of an optional shape having, high ion conductivity, and high dense with less water permeability can be obtained by sintering an inorganic powder, preferably, a lithium ion conductive inorganic powder and, particularly preferably, a powder of glass or crystal (ceramics or glass ceramics) to reduce a porosity to a predetermined value or less. Particularly, it has been found that a dense sintered material is obtained by molding a powder containing the inorganic powder, preferably, the lithium ion conductive inorganic powder as a main ingredient and then sintering the same after densification under pressing and/or while pressing, and a battery obtained by disposing a positive electrode and a negative electrode on both surfaces of an electrolyte obtained from the sintered material has higher power and capacity compared with an existent solid electrolyte battery, is remarkably improved also for charge/discharge cyclic characteristic, and that water content formed at the air electrode less reaches the lithium metal electrode to provide safety, and have accomplished the invention.

That is, preferred embodiments of the invention can be represented by the following constitutions.

### (Constitution 1)

A lithium ion conductive solid electrolyte formed by sintering a molding product containing an inorganic powder and having a porosity of 10 vol % or less.

### (Constitution 2)

A lithium ion conductive solid electrolyte according to the constitution 1, wherein a composition containing the inorganic powder is press molded and then sintered.

### (Constitution 3)

A lithium ion conductive solid electrolyte according to the constitution 1, wherein the molding product is sintered under pressing.

### (Constitution 4)

A lithium ion conductive solid electrolyte according to any one of constitutions 1 to 3, wherein the inorganic powder contains 10 vol % or less of particles of 50 μm or more.

### (Constitution 5)

A lithium ion conductive solid electrolyte according to any one of constitutions 1 to 4, wherein the maximum particle size of the inorganic powder is 15 times or less of an average particle size.

### (Constitution 6)

A lithium ion conductive solid electrolyte according to any one of constitutions 1 to 5, wherein the average particle size of the inorganic powder is 2 μm or less.

### (Constitution 7)

A lithium ion conductive solid electrolyte according to any one of constitutions 1 to 6, wherein the lithium ion conductivity of the inorganic powder is 1×10⁻⁷ Scm⁻¹ or higher at 25° C.

### (Constitution 8)

A lithium ion conductive solid electrolyte according to any one of constitutions 1 to 7, wherein the inorganic powder contains lithium, silicon, phosphorus, or titanium.

### (Constitution 9)

A lithium ion conductive solid electrolyte according to any one of constitutions 1 to 8, wherein the inorganic powder contains crystals of Li_{1+x+y}(Al, Ga)ₓ(Ti, Ge)₂Si_{y}P_{3-y}O₁₂ in which 0≦x≦1, 0≦y≦1.

### (Constitution 10)

A lithium ion conductive solid electrolyte according to constitution 9, wherein 50 wt % or more of crystals are contained in the inorganic powder.

### (Constitution 11)

A lithium ion conductive solid electrolyte according to constitution 9 or 10, wherein the crystals are crystals not containing pores or crystal grain boundaries that hinder the ion conduction.

### (Constitution 12)

A lithium ion conductive solid electrolyte according to any one of constitutions 1 to 11, wherein the inorganic powder is glass ceramics.

### (Constitution 13)

A lithium ion conductive solid electrolyte according to any one of constitutions 1 to 12, wherein the lithium ion conductive crystals are contained by 50 wt % or more.

### (Constitution 14)

A lithium ion conductive solid electrolyte according to any one of constitutions 1 to 13, wherein the lithium ion conductive glass ceramics are contained by 80 wt % or more.

### (Constitution 15)

A lithium ion conductive solid electrolyte according to any one of constitutions 1 to 14, wherein the solid electrolyte contains glass ceramics comprising each of the ingredients, based on mol %,

Li₂O: 12 to 18%,

Al₂O₃+Ga₂O₃: 5 to 10%,

TiO₂+GeO₂: 35 to 45%,

SiO₂: 1 to 10%, and

P₂O₅: 30 to 40%.

### (Constitution 16)

A lithium ion conductive solid electrolyte according to any one of constitutions 1 to 8, wherein the inorganic powder is glass.

### (Constitution 17)

A lithium ion conductive solid electrolyte according to any one of constitutions 1 to 16, wherein the lithium ion conductivity is 1×10⁻⁴ Scm⁻¹ or higher at 25° C.

### (Constitution 18)

A primary lithium battery having a lithium ion conductive solid electrolyte according to any one of constitutions 1 to 17.

### (Constitution 19)

A secondary lithium ion battery having a lithium ion conductive solid electrolyte according to any one of constitutions 1 to 17.

### (Constitution 20)

A process for producing a lithium ion conductive solid electrolyte of preparing a molding product using an inorganic powder as a main ingredient, and then sintering the molding product after pressing.

### (Constitution 21)

A process for producing a lithium ion conductive solid electrolyte of preparing a molding product using an inorganic powder as a main ingredient and sintering the same while pressing.

### (Constitution 22)

A process for producing a lithium ion conductive solid electrolyte according to constitution 20 or 21, wherein the inorganic powder contains 10 vol % or less of particles of 50 μm or larger.

### (Constitution 23)

A process for producing a lithium ion conductive solid electrolyte according to any one of constitutions 20 to 22, wherein the maximum particle size of the inorganic powder is 15 times or less of the average particle size.

### (Constitution 24)

A process for producing a lithium ion conductive solid electrolyte according to any one of constitutions 20 to 23, wherein the average particle size of the inorganic powder is 2 μm or less.

### (Constitution 25)

A process for producing a lithium ion conductive solid electrolyte according to any one of constitutions 20 to 24, wherein the lithium ion conductivity of the inorganic powder is 1×10⁻⁷ Scm⁻¹ or higher at 25° C.

### (Constitution 26)

A process for producing a lithium ion conductive solid electrolyte according to any one of constitutions 20 to 25, wherein the inorganic powder contains crystals of Li_{1+x+y}(Al, Ga)ₓ(Ti, Ge)₂₋ₓSi_{y}P_{3-y}O₁₂, in which 0≦x≦1, and 0≦y≦1.

### (Constitution 27)

A process for producing a lithium ion conductive solid electrolyte according to constitution 26, wherein the crystal is a crystal not containing pores or crystal grain boundaries that hinder the ion conduction.

### (Constitution 28)

A process for producing a lithium ion conductive solid electrolyte according to any one of 20 to 27, wherein the inorganic powder is glass ceramics.

### (Constitution 29)

A process for producing a lithium ion conductive solid electrolyte according to any one of 20 to 25, wherein the inorganic powder is glass.

### (Constitution 30)

A process for producing a lithium ion conductive solid electrolyte according to any one of 20 to 29, wherein the porosity of the molding product before sintering is 60% or less.

The present invention provides a lithium ion conductive solid electrolyte for use in a secondary lithium ion battery and a primary lithium battery having a high battery capacity without using a liquid electrolyte and a good charge/discharge cycle characteristics, and usable stably for a long time, and a production process capable of easily obtaining the same.

Further, the invention provides production processes capable of easily obtaining a lithium ion conductive solid electrolyte which is dense with less water permeability and capable of easily obtaining a safe lithium metal air battery.

According to the production process of the invention, solid electrolyte of various shapes can be molded simply, efficiently and at a reduced cost.

The solid electrolyte of the invention can provide an ion conductivity at a value of 1×10⁻⁴ Scm⁻¹ or higher and at a value of 3×10⁻⁴ Scm⁻¹ or higher in a preferred embodiment and, at a value of 4×10⁻⁴ Scm⁻¹ or higher at 25° C. in a more preferred embodiment with an overall point of view.

### DETAILED DESCRIPTION OF THE INVENTION

Preferred embodiments of the present invention are to be described in details.

The solid electrolyte of the invention is obtained by manufacturing a molding product containing an inorganic powder and, preferably, a lithium ion conductive inorganic powder, and sintering the same after pressing, or sintering the same while pressing and has a porosity of 10 vol % or less.

For molding product, press molding or injection molding using a simple die, doctor blade, or the like can be used and since the molding product can be prepared by kneading the raw material with addition of a binder, etc., then by using a general-purpose apparatus such as extrusion or injection molding apparatus, so that solid electrolytes of various shapes can be molded simply, efficiently and at a reduced cost.

In a case where pores are present in the inside of a solid electrolyte, since ion conduction channels are not present in the portion, the ion conductivity of the solid electrolyte per se is lowered. In a case of using the solid electrolyte of the invention for the application use of a battery, since the ion conductivity of the solid electrolyte is high, the transfer speed of lithium ions is fast and a battery of high power can be obtained. In addition, in a case where the porosity is within the range as described above, the solid electrolyte becomes more dense and the water permeability can be within a safe range also in a case of use for the battery using the air electrode. The porosity in the solid electrolyte is preferably lower and it is preferably 10 vol % or less with a view point of ion conductivity and with a view point of the water permeability which can be used practically as the battery. It is more preferably 7 vol % or less and, most preferably, 4 vol % or less. For reducing the porosity to 10 vol % or less, it is preferred to press the molding product before sintering or sintering the molding product while pressing.

By pressing the lithium ion conductive inorganic powder, for example, by isostatic pressing after molding, the molding product before sintering is densified. Since this enables to heat the molding product uniformly during sintering, sintering also proceeds along the uniform direction in the material and, as a result, it is possible to obtain a solid electrolyte which is extremely dense with the porosity being 10 vol % or less.

The porosity means herein the ratio of pores contained in a unit volume, which is represented by the following equation:

Porosity(%)=(true density−bulk density)/true density×100

The true density is a density of a material per se that can be measured by a known method such as Archimedes method. On the contrary, the bulk density is a density obtained by dividing the weight of an object with an apparent volume, which is a density also including apertures on the surface and pores in the inside of the object. As a measuring method, the bulk density can be determined as weight/volume by measuring the weight and the volume of a specimen fabricated into a shape easy to be measured (square or cylindrical shape).

Since the molding product containing a lithium ion conductive inorganic powder can be heated uniformly as far as the inside during sintering by making the inside into a dense and uniform composition, sintering also proceeds along a uniform direction in the material and, as a result, a solid electrolyte with less pores can be obtained. Further, a sintered material (solid electrolyte) which is dense with less porosity can be obtained by making the particle size of the raw material smaller and mixing the same sufficiently to make the composition of the molding product uniform, pressing the same before sintering by isostatic pressing, etc. thereby densifying the same. Further, a solid electrolyte of higher dense and higher ion conductivity can be obtained by pressing during sintering using, for example, hot pressing or HIP (hot isostatic pressing).

For pressing the molding product, dry or wet CIP (cold isostatic pressing) apparatus is used preferably. Further, for sintering under pressing, hot press or HIP (hot isostatic pressing) apparatus is used preferably.

Particularly, also in a case of pressing a solid electrolyte of any shape, shape before pressing can be maintained by using an isostatic pressing method such as CIP or HIP and since the electrolyte of any shape can be obtained as it is with no requirement of subsequent fabrication, a solid electrolyte of a required shape can be obtained easily.

The average particle size of the starting powder is, preferably, 2 μm or less, more preferably, 1.5 μm or less and, most preferably, 1 μm or less. A lithium ion conductive solid electrolyte which is dense with less porosity also after sintering can be obtained by refining the starting material with an average particle size of 2 μm or less and then mixing the same sufficiently thereby making the composition of the molding product uniform.

The average particle size is an averaged volume% obtained by measurement with a laser diffraction system, a laser scattering system or by the combination thereof and, specifically, it corresponds to 50 vol % upon accumulation from a smaller particle size in the particle size distribution on the volume base (D50), which is a value generally represented by D50.

Further, in a case of obtaining a molding product by sintering the inorganic powder after molding to an optional shape, when the sinterability of the powder is favorable, a good molding product can be obtained by press-molding and sintering with no strict control for the average particle size and the particle size distribution. However, in a case of using an inorganic powder of poor sinterability, since the average particle size described above has a significant effect on the density of the obtained molding product, it is more necessary to make the average particle size smaller as the sinterability is worsened and, depending on the case, it is preferred to control also the particle size distribution.

In a case where the particle size distribution of the starting powder is wide and large particles are present, the sinterability is lowered to result in a possibility that no dense sintered material can be obtained. Therefore, it is necessary to decrease the amount of large particles of the starting powder and it is preferred that the particles of 50 μm or more are 10 vol % or less, that is, 90 vol % upon accumulation from the smaller particle size in the particle size distribution (D90) is 50 μm or less. Further, since the sinterability is higher as the amount of particles of 50 μm or more is smaller, it is preferred that the particles of 50 ηm or more are 5% or less and it is most preferred that particles of 50 μm or more are not present, that is, the maximum particle size is 50 μm or less.

Further, for uniformly sintering the powder as far as the inside of the material making it dense, it is necessary to control the particle size distribution and, in a case where the particle size distribution is excessively wide, difference is caused for the sinterability of the materials. In view of the above, the maximum particle size is, preferably, 15 times or less, more preferably, 10 times or less and, most preferably, 7 times or less of the average particle size.

In a case of press-molding and sintering an inorganic powder with no favorable sinterability, the area of contact between each of the particles increases to enable more dense sintering when the density before sintering is higher. In a case where the density of the molding product before sintering is low (with more pores), since the effect of the volumic change accompanying sintering may possibly give an effect on the shape after sintering, it is preferred to sinter a molding product of a density as high as possible. The porosity before sintering is, preferably, 60 vol % or less, more preferably, 50 vol % or less and, most preferably, 40 vol % or less.

The inorganic powder used in the invention is preferably a powder of an inorganic material containing a lithium ion conductive glass powder, a lithium ion conductive crystal (ceramic or glass ceramic) powder or a powder of the mixture thereof, or the powder (glass powder, a crystal powder or a mixed powder of glass and crystal). Further, also the inorganic material with no so high lithium ion conductivity (for example, at 1×10⁻⁷ Scm⁻¹) can be used so long as the ion conductivity is increased to 1×10⁻⁴ Scm⁻¹ or higher at 25° C. by sintering after pressing or sintering under pressing. Since high lithium ion conductivity can be obtained easily in the lithium ion conductive inorganic powder by incorporating lithium, silicon, phosphorus, and titanium as the main ingredient, it is preferred to contain the ingredients described above as the main ingredient.

Since higher conductivity can be obtained by containing more lithium ion conductive crystals in the solid electrolyte, it is preferred to contain 50 wt % or more of lithium ion conductive crystals in the solid electrolyte. The content is, more preferably, 55 wt % or more and, most preferably, 60 wt % or more.

Further, since higher conductivity is obtained by containing more crystals also in the lithium ion conductive inorganic powder contained in the molding product for obtaining the solid electrolyte, it is preferred that the lithium ion conductive inorganic powder contains 50 wt % or more of lithium ion conductive crystals. It is, more preferably, 55 wt % or more and, most preferably, 60 wt % or more.

Also, even inorganic powders not having high ion conductivity as described above, so long as they have high ion conductivity by sintering after pressing or during pressing, they result in no problems when crystals are not contained in the molding product before sintering. Specifically, any of crystal, glass, or mixture thereof can be used for the inorganic powder when the solid electrolyte after sintering develops a high ion conductivity by heating glass or mixture with no ion conductivity thereby causing crystallization or solid phase reaction.

The lithium ion conductive crystals usable herein include crystals having a perovskite structure having a lithium ion conductivity such as LiN, LISICON, La_{0.55}Li_{0.35}TiO₃, LiTi₂P₃O₁₂ having an NASICON type structure or glass ceramics in which such crystals are precipitated. Preferred lithium ion conductive crystals are Li_{1+x+y}(Al,Ga)ₓ(Ti,Ge)₂₋ₓSi_{y}P_{3-y}O₁₂ in which 0—x—1 and 0≦y≦1, more preferably, 0≦x≦0.4 and 0≦y≦0.6 and, most preferably, 0.1≦x≦0.3 and 0.1≦y≦0.4. Crystals not containing crystal grain boundaries hindering the ion conduction are advantageous in view of ion conduction. Particularly, glass ceramics are more preferred since they scarcely have pores or crystal grain boundaries that hinder the ion conduction and, accordingly, have high ion conductivity and are excellent in chemical stability. Further, materials other than glass ceramics and having scarce pores or crystal grain boundaries that hinder the ion conduction include single crystals of the crystals described above but they are difficult to manufacture and expensive. Lithium ion conductive glass ceramics are advantageous also with a view point of easy production and cost.

Examples of the lithium ion conductive glass ceramics include those glass ceramics, using matrix glass of a Li₂O—Al₂O₃—TiO₂—SiO₂—P₂O₅ series composition, which is applied with a heat treatment to be crystallized and in which the main crystal phase is Li_{1+x+y}AlₓTi₂₋ₓSi_{y}P_{3-y}O₁₂ (0≦x≦1, 0≦y≦1). It is more preferably: 0≦x≦0.4, 0≦x≦0.6 and, most preferably, 0.1≦x≦0.3, 0.1≦y≦0.4.

The pores or crystal grain boundaries that hinder the ion conduction mean an ion conduction hindering material such as having pores or crystal grain boundaries of decreasing the conductivity of the entire inorganic material containing the lithium ion conductive crystals to 1/10 or less relative to the conductivity of the lithium ion conductive crystals per se in the inorganic material.

The glass ceramics referred to herein are materials obtained by precipitating a crystal phase in a glass phase by applying a heat treatment to glass, which mean a material comprising an amorphous solid and a crystal. Further, the glass ceramics include those materials in which the glass phase is entirely caused to phase transfer to the crystal phase in a case where vacant pores are scarcely present between the grains of crystals or in the crystals, that is, those in which the amount of crystals in the material (crystallized ratio) is 100 mass %. In so-called ceramics or sintered material thereof, presence of pores or crystal grain boundaries is inevitable between the grains of the crystals and in the crystals in view of the manufacturing step thereof and they can be distinguished from the glass ceramics. Particularly, with respect to the ion conduction, the value of the conductivity is rather lower than that of the crystal grain per se in the case of the ceramics due to the presence of the pores or the crystal grain boundaries. In the glass ceramics, lowering of the conductivity between the crystals can be suppressed by the control of the crystallization step and the conductivity about equal with that of the crystal grains can be kept.

Since higher conductivity can be obtained by containing more glass ceramics in the solid electrolyte, lithium ion conductive glass ceramics are contained in the solid electrolyte, preferably, by 80 wt % or more, more preferably, 85 wt % or more and, most preferably, 90 wt % or more.

The mobility of lithium ions during charge/discharge of the secondary lithium ion battery and during charge of the primary lithium battery depends on the lithium ion conductivity and lithium ion transport number of the electrolyte. Accordingly, for the solid electrolyte of the invention, a material of high lithium ion conductivity and high lithium ion transport number is used preferably.

The ion conductivity of the lithium ion conductive inorganic powder is, preferably, 1×10⁻⁴ S·cm⁻¹ or higher at 25° C., more preferably, 5×10⁻⁴ S˜cm⁻¹ or higher at 25° C. and, most preferably, 1×10⁻³ S·cm⁻¹ or higher at 25° C.

In a case of an inorganic powder whose ion conductivity becomes higher by sintering after pressing or during pressing as described above, the ion conductivity before sintering is, preferably, 1×10⁻⁷ S·cm⁻¹ or higher.

One of preferred forms of the composition of the lithium ion conductive inorganic powder includes, for example, composition to be described later. A powder formed from a glass having the composition is shown as an example of those having an ion conductivity increased to 1×10⁻⁴ S˜cm⁻¹ or higher by sintering after pressing or during pressing described above.

Further, glass ceramics comprising glass having the composition as the matrix glass and applied with a heat treatment to precipitate crystals forms glass ceramics in which a main crystal phase comprises Li_{1+x°y}(Al,Ga)ₓ(Ti,Ge)₂₋ₓSi_{y}P_{3-y}O₁₂ (0≦x≦1, and 0≦y≦1), a composition ratio represented by mol % for each of the ingredients and the effect are described specifically.

A Li₂O ingredient is an ingredient which is essential to provide Li⁺ ion carriers and provide a lithium ion conductivity. For obtaining a good conductivity, the lower limit of the content is preferably 12%, more preferably, 13% and, most preferably, 14%. On the contrary, in a case where the Li₂O ingredient is excessive, since thermal stability of the glass tends to be worsened and also the conductivity of the glass ceramics tends to be lowered, so that the upper limit of the content is, preferably 18%, more preferably, 17% and, most preferably, 16%.

An Al₂O₃ ingredient can improve the thermal stability of the matrix glass and, at the same time, Al³⁺ ions are solid solubilized into the crystal phase to provide also an effect for the improvement of the lithium ion conductivity. For obtaining the effect, the lower limit of the content is, preferably, 5%, more preferably, 5.5% and, most preferably, 6%. However, in a case where the content exceeds 10%, since this rather tends to worsen the thermal stability of the glass and tends to lower the conductivity of the glass ceramics, the upper limit of the content is preferably 10%. A more preferred upper limit of the content is 9.5% and the most preferred upper limit of the content is 9%.

A TiO₂ ingredient contributes to the formation of glass, and it is also a constituent ingredient of the crystal phase and a useful ingredient also in the crystals and the glass. For vitrification and for obtaining high conductivity by the precipitation of the crystal phase as a main phase from the glass, the lower limit of the content is preferably, 35%, more preferably, 36% and, most preferably, 37%. Further, in a case where the TiO₂ ingredient is excessive, since the thermal stability of the glass tends to be worsened and the conductivity of the glass ceramics also tends to be lowered, the upper limit of the content is preferably, 45%, more preferably, 43% and, most preferably, 42%.

An SiO₂ ingredient can improve the melting property and the thermal stability of the matrix glass and, at the same time, Si⁴⁺ ions are solid solubilized in the crystal phase to also contribute to the improvement of the lithium ion conductivity. For obtaining the effect sufficiently, the lower limit of the content is, preferably, 1%, more preferably, 2% and, most preferably, 3%. However, since the conductivity tends to be rather lowered in a case where the content exceeds 10%, the upper limit of the content is preferably 10%, more preferably, 8% and, most preferably, 7%.

A P₂O₅ ingredient is an ingredient essential to the formation of glass. Further, it is also a constituent ingredient for the crystal phase. Since vitrification becomes difficult in a case where the content is less than 30%, the lower limit of the content is, preferably, 30%, more preferably, 32% and, most preferably, 33%. Further, since the crystal phase is less precipitated from the glass in a case where the content exceeds 40%, making it difficult to obtain desired characteristics, the upper limit of the content is, preferably, 40%, more preferably, 39% and, most preferably, 38%.

In the case of the composition described above, the glass can be obtained easily by casting molten glass and glass ceramics having the crystal phase described above obtained by heat-treating the glass have high lithium ion conductivity.

Further, in addition to the compositions described above, Al₂O₃ can be replaced with Ga₂O₃, and TiO₂ can be replaced with GeO₂ partially or entirely so long as the glass ceramics have similar crystal structures. Further, upon preparation of glass ceramics, other materials may also be added for lowering the melting point thereof or improving the stability of glass within a range not greatly worsening the ion conductivity.

It is desirable that alkali metal ingredients such as Na₂O or K₂O other than Li₂O are not contained as much as possible in the composition of the glass ceramics. In a case where the ingredients are present in the glass ceramics, the mixing effect of alkali ions hinders the conduction of Li ions tending to lower the conductivity.

Further, while the addition of sulfur to the composition of the glass ceramics somewhat improves the lithium ion conductivity, since this worsens the chemical endurance or stability, it is desirable that sulfur is not contained as much as possible. For the composition of the glass ceramics, it is also desirable that ingredients such as Pb, As, Cd, or Hg that may possibly cause damages to the environments or human bodies are not contained as much as possible.

The production process for the solid electrolyte of the invention has a feature of preparing a molding product comprising a lithium ion conductive inorganic powder as a main ingredient and sintering the molding product in which the molding product is pressed at least once from the start of the preparation of the molding product to the completion of sintering.

A solid electrolyte of high density with less porosity and high ion conductivity can be obtained by molding a lithium ion conductive inorganic powder, that is, a powder of glass or crystal (ceramics or glass ceramics) having high lithium ion conductivity and chemical stability or a mixture of such powders into an optional shape by using press molding or injection molding using a die or a doctor blade, pressing to densify the same by using a general-purpose apparatus such as dry or wet CIP and then sintering the same. Further, a solid electrolyte of high density and having higher ion conductivity can be obtained by sintering while pressing by using an apparatus such as hot press or HIP during sintering.

In the molding before pressing, a molding product is molded by using not only a lithium ion conductive inorganic powder but also a solvent together with an organic or inorganic binder or, optionally, a dispersant and mixing them into a slurry by a simple manufacturing method such as press molding or injection molding, doctor blade method or the like, drying the solvent, pressing in CIP or the like and then sintering the same. In this case, since the organic ingredient of the organic binder contained in the molding product is removed during sintering, a sintered product not containing an organic matter (solid electrolyte) is obtained. For the organic binder used herein, general-purpose binders commercially available as molding aids for press molding, rubber press, extrusion molding, or injection molding can be used. Specifically, acrylic resin, ethyl cellulose, polyvinyl butyral, methacryl resin, urethane resin, butylmethacrylate and vinylic copolymers can be used. In addition to the binders described above, a dispersant for improving the dispersibility of particles, a surfactant for making the defoaming favorable during drying can also be added each by an appropriate amount. Since the organic materials are removed during sintering, it may be used with no troubles for the viscosity control of the slurry during molding.

Further, the molding product to be sintered may also be incorporated with an Li-containing inorganic compound. The Li-containing inorganic compound serves as a sintering aid (binder) to function for binding glass ceramic particles.

The Li-containing inorganic compound includes Li₃PO₄, LiPO₃, LiI, LiN, Li₂O, Li₂O₂, LiF, etc. Particularly, the Li-containing inorganic compound, when mixed and sintered together with lithium ion conductive crystal-containing inorganic materials or glass ceramics, can soften or melt them by controlling the sintering temperature and atmosphere. The softened or molten Li-containing inorganic compound flows into the gaps between glass ceramic particles and can firmly bond the inorganic materials or glass ceramics containing lithium ion conductive crystals.

Further, in a case of intending to improve the electron conductivity without hindering the lithium ion conductivity, other inorganic powders or organic materials may be added with no problems.

Addition of a small amount of highly dielectric and highly insulative crystal or glass as an inorganic powder can sometimes improve the diffusibility of lithium ions to obtain an effect of improving the lithium ion conductivity. They include, for example, BaTiO₃, SrTiO₃, Nb₂O₅, LaTiO₃, etc.

Since the solid electrolytes obtained by sintering can be obtained in the shape as molded, they can be easily fabricated into any shape and, accordingly, solid-electrolyte of an optional shape, or all solid state primary lithium battery or secondary lithium ion battery using the solid electrolyte can be produced.

Since the pressed and sintered molding product is dense and uniform, fabrication such as cutting or grinding is easy and the surface can be ground optionally in the application use. Particularly, in a case of attaching a thin electrode or the like to the surface, a favorable contact boundary is obtained by grinding and polishing the surface. Further, since the solid electrolyte after sintering contains no organic materials, it is excellent in the heat resistance and the chemical durability and causes less damages to the safety or environment.

For the positive electrode material of the primary lithium battery according to the invention, transition metal compounds or carbon materials capable of occluding lithium can be used. For example, transition metal oxides containing at least one member selected from manganese, cobalt, nickel, vanadium, niobium, molybdenum, and titanium, and graphite, or carbon, etc. can be used.

Further, for the negative electrode material of the primary lithium battery, alloys capable of releasing lithium such as metal lithium, lithium-aluminum alloys, lithium-indium alloys, etc. can be used.

As the active material used for the positive electrode material of the secondary lithium ion battery according to the invention, transition metal compounds capable of occluding and releasing lithium can be used and, for example, transition metal oxides containing at least one member selected from manganese, cobalt, nickel, vanadium, niobium, molybdenum, and titanium can be used.

Further, as the active material used for the negative electrode material in the secondary lithium battery, metal lithium or alloys capable of occluding and releasing lithium such as lithium-aluminum alloys, lithium-indium alloys, etc., transition metal oxides such as of titanium and vanadium, and carbonaceous materials such as graphite are used preferably.

For the positive electrode and the negative electrode, addition of materials identical with those for the glass ceramics contained in the solid electrolyte are more preferred since the ion conduction is provided. When they are identical, since the ion transferring mechanism contained in the electrolyte and the electrode material are unified, ions can be transferred smoothly between the electrolyte and the electrode to provide a battery of higher power and higher capacity.

### EXAMPLE

A solid electrolyte containing lithium ion conductive glass ceramics according to the invention, and a secondary lithium ion battery and a primary lithium battery using the same are to be described with reference to specific examples. The invention is not restricted to those shown in the following examples and can be practiced with an appropriate modification within a range not departing from the gist thereof.

### Example 1

As the starting material, H₃PO₄, Al(PO₃)₃, Li₂CO₃, SiO₂, and TiO₂ were used and, after weighing so as to form a composition comprising 35.0% of P₂O₅, 7.5% of Al₂O₃, 15.0% of Li₂O, 38.0% of TiO₂, and 4.5% of SiO₂ based on the oxide equivalent mol % and uniformly mixing them, they were placed in a platinum pot and melted under heating at 1500° C. in an electric furnace for 3 hours while stirring the molten glass liquid. Then, the molten glass liquid was dropped in running water to obtain flaky glass and the glass was crystallized by a heat treatment at 950° C. for 12 hours to obtain aimed glass ceramics. It was confirmed by powder X ray diffractiometry that the precipitated crystal phase comprised of Li_{1+x+y}AlₓTi₂₋ₓSi_{y}P_{3-y}O₁₂ in which 0≦x≦0.4, and 0≦y≦0.6 as the main crystal phase. The obtained flakes of the glass ceramics were milling by a dry jet mill to obtain a powder of glass ceramics of an average particle size of 2 μm, with a maximum particle size of 10 μm and without containing particles of 50 μm or larger. For the particle size measurement, a laser diffraction scattering type particle size distribution measuring apparatus LS 100 manufactured by Beckman Coulter Co. was used and distilled water was used as a dispersion medium. Further, the ion conductivity of the powder was 1.3×10⁻⁴ Scm⁻¹ at room temperature (25° C.).

The obtained powder was filled in a cylindrical rubber die of 60 mmφ inner diameter and 50 mm inner height, the rubber die was sealed in a thin plastic bag and then subjected to vacuum deaeration and heat sealing to apply tight sealing. The tightly sealed rubber die was placed in a wet CIP apparatus and pressed under a pressure of 2.5 t for 30 min to densify. The densified molding product was taken out of the rubber die, sintered at 1050° C. in an atmospheric air to obtain a sintered material (solid electrolyte). After slicing the obtained sintered material, both surfaces were ground to obtain a solid electrolyte of 0.3 mm thickness. An AU electrode was attached by sputtering on both surfaces of the obtained solid electrolyte and as a result of complex impedance measurement by an AC 2-terminal method, the ion conductivity was 2.9×10⁻⁴ Scm⁻¹ at 25° C. and the porosity was 6.1 vol %.

### Comparative Example 1

Glass ceramics identical with those in Example 1 were packed in a zirconia die of 40 mmφand sintered at 1050° C. for identical times. After sintering, when they were taken out of the die, the ion conductivity was 3.1×10⁻⁶ Scm⁻¹ at 25° C. and the porosity was 31 vol %.

### Example 2

Glass ceramics identical with those in Example 1 were milling by a ball mill and classified again by using a jet mil to obtain a powder of glass ceramics with an average particle size of 0.8 μm, maximum particle size of 5.5 μm, without containing particles of 50 μm or larger. For particle size measurement, a laser diffraction-scattering type particle size distribution measuring apparatus LS 100 manufactured by Beckman Coulter Co. was used and distilled water was used as a dispersion medium. The ion conductivity of the powder was 1.3×10⁻⁴ Scm⁻¹ at 25° C.

The obtained powder was filled in a rubber die in the same manner as in Example 1, and pressed in a CIP apparatus at a pressure of 2.5 t for 30 min to densify, sintered in an atmospheric air at 1050° C. to obtain a sintered material (solid electrolyte). After slicing the obtained sintered material, both surface were ground to obtain a solid electrolyte of 0.3 mm thickness. The obtained solid electrolyte had an ion conductivity of 3.4×10⁻⁴ Scm⁻¹ at 25° C. and a porosity of 5.6 vol %.

### Example 3

Glass ceramics obtained in Example 2 were placed in a ball mill apparatus, subjected to wet milling using ethanol s a solvent and dried by a spray dryer to obtain a fine powder having a fine and sharp particle size distribution in which the primary particles had an average particle size of 0.3 μm, a maximum particle size of 0.5 μm without containing particles of 50 μm or more. For the particle size measurement, a laser scattering type particle size distribution measuring apparatus N5 manufactured by Beckman Coulter Co. was used and distilled water was used as a dispersion medium.

In the same manner as in Example 1, the obtained powder was pressed to densify in a CIP apparatus under a pressure of 2.5 t for 30 min, and sintered in an atmospheric air at 1050° C. to obtain a sintered material (solid electrolyte). The obtained solid electrolyte had an ion conductivity of 3.7×10⁻⁴ Scm⁻¹ at 25° C and a porosity of 4.7 vol %.

### Comparative Example 3

Glass ceramics identical with those in Example 3 were packed in a zirconia die of 40 mmφ and sintered at 1050° C. for identical time. After sintering, when they were taken out of the die, the ion conductivity was 5.7×10⁻⁶ Scm⁻¹ at 25° C. and the porosity was 27 vol %.

### Example 4

The glass ceramics powder of 0.8 μm average particle size obtained in Example 2 and a powder of 0.3 μm average particle size obtained in Example 3 were weighed at a 80:20 ratio and mixed thoroughly by a ball mill.

The mixed powder material was pressed to densify in the same manner as in Example 1 by a CIP apparatus under a pressure of 2.5 t for 30 min, and sintered in an atmospheric air at 1050° C. to obtain a sintered material (solid electrolyte). The obtained solid electrolyte had an ion conductivity of 4.0×10⁻⁴ Scm⁻¹ at 25° C. and a porosity of 3.7 vol %.

### Example 5

Glass ceramics of 0.8 μm average particle size obtained in Example 2 were dispersed and mixed using water together with urethane resin and a dispersing agent as a solvent to prepare a slurry, which was molded by a doctor blade method and dried to remove the solvent and obtain a plate-like molding product. The molding product was sandwiched on both surfaces thereof with hard polyethylene plates, subjected to vacuum deaeration and sealing, and then pressed to densify in a CIP apparatus under a pressure of 2.5 t for 30 min. Organic materials were removed in an atmospheric air at 400° C. and then sintered at 1050° C. to obtain a sintered material (solid electrolyte). The ion conductivity was 3.2×10⁻⁴ Scm⁻¹ at 25° C. The porosity was 5.0 vol %.

### Example 6

Glass before crystallization obtained in Example 1 was milling in a ball mill into a powder of 1 μm average particle size and 7 μm maximum particle size. Particles of 50 μm or larger were not contained. For the measurement of the particle size, a laser diffraction-scattering type particle sizes distribution measuring apparatus Ls 100 manufactured by Beckman Coulter Co. was used and distilled water was used as the dispersion medium. The obtained powder was dispersed and mixed together with a urethane resin and a dispersant using water as a solvent to prepare a slurry and, in the same manner as in Example 5, molded into a plate shape and then subjected to CIP pressing to densify. In an atmospheric air, organic materials were removed at 400° C. and crystallization was conducted at 700° C. and then sintering was conducted at 1050° C. to obtain a solid electrolyte. The ion conductivity was 3.8×10⁻⁴ Scm⁻¹ at 25° C. The porosity was 6.0 vol %.

### Example 7

The sintered material obtained in Example 1 was placed in an alumina crucible and sintered while pressing in an HIP apparatus. It was sintered at 1075° C. while pressing up to 180 MPa (about 1.8 t) in an argon gas atmosphere with addition of 20% oxygen.

After sintering, the ion conductivity was 3.6×10⁻⁴ Scm⁻¹ at 25° C. and the porosity was 3.8 vol %. The ion conductivity was improved and the porosity was decreased compared with Example 1, and a dense solid electrolyte was obtained.

### Example 8

Li₃PO₄ was added by 1% by weight to the powder of the glass ceramics obtained in Example 1 and they were mixed in a ball mill. The powder had a 2 μm average particle size, and 10 μm of maximum particle size, without containing particles of 50 μm or more. For the particle size measurement, a laser diffraction-scattering type particle size distribution measuring apparatus LS100 manufactured by Beckman Coulter Co. was used and distilled water was used as the dispersion medium. The mixed starting powder was sintered under the same condition as in Example 1.

After sintering, the ion conductivity was 3.4×10⁻⁴ Scm⁻¹ at 25° C. and the porosity was 5.3 vol %. The ion conductivity was improved and the porosity was decreased compared with Example 1, and a more dense solid electrolyte was obtained by the addition of the Li-containing inorganic compound.

### Example 9

The solid electrolyte glass ceramics obtained in Example 2 was bored into a disk-like shape to 20 mmφ and 0.3 mm thickness and a primary lithium battery was assembled using the disk. Commercially available MnO₂ was used for the positive electrode active material, which was kneaded with acetylene black as a conductive reagent and PVDF (polyvinylidene fluoride) as a binder and molded to 0.3 mm thickness by a roll press and punched to a circular shape of 18 mmφ to prepare a positive electrode material.

Al was sputtered on one surface of the solid electrolyte, on which an Li—Al alloy negative electrode of 18 mmφ was bonded to form a negative electrode, and a prepared positive electrode material was bonded on the other surface to which a positive electrode was attached. The prepared cell was placed in a coin cell made of stainless steel, and a mixed solvent of propylene carbonate and 1,2-dimethoxyethane with addition of 1 mol % of LiClO₄ as a Li salt was charged in the coin cell and sealed to manufacture a primary lithium battery. When the thus manufactured battery was subjected to a discharge test at a room temperature of 25° C., 3 V of average driving voltage and 30 mAh or more of capacity were obtained. In the coin battery, since the solid electrolyte was fixed in the inside and distortion due to the volumic change of the electrode by the discharge did not occur as in the existent resin separator, the discharge potential could be maintained stably to the last during use.

### Example 10

The solid electrolyte obtained in Example 3 was cut out into a 30×30 mm plate shape and both surfaces were ground and polished to 120 μm thickness, and an all solid state secondary lithium ion battery was assembled by using the same as the electrolyte.

A slurry containing LiCoO₂ as an active material and lithium ion conductive glass ceramics fine powder obtained in Example 3 as an ion conductive reagent was coated, dried and sintered on one surface of the solid electrolyte, and a positive electrode material was attached. Al was sputtered on the positive electrode layer and an Al positive electrode collector was attached.

On the other surface, a slurry containing Li₁₄Ti₅O₁₂ as the active material, a fine powder of lithium ion conductive glass ceramics as that used for the positive electrode as an ion conductive aid was coated, dried and calcined, and a negative electrode material was attached. A paste containing fine particles of cupper was coated, dried and calcined onto the negative electrode to attach the negative electrode collector, which was sealed in a coin cell to assemble a battery. It could be confirmed that the battery could be charged at 3.5V and driven at an average discharge voltage of 3V. By discharging the battery to 2.5V and then charging at 3.5V, it could be confirmed that this is a secondary lithium ion battery driven at an average discharge voltage of 3V again.

### Example 11

A solid electrolyte obtained in Example 4 was cut out into a 20 mmφ plate shape, and both surfaces were ground and polished to 90 μm thickness, and a secondary lithium ion battery using the same as the electrolyte was assembled.

A slurry containing LiCoO₂ as an active material, and lithium ion conductive glass ceramics of 0.3 μm average particle size as an ion conductive reagent was coated, dried and calcined on one surface of the solid electrolyte to attach a positive electrode material. The thickens of the positive electrode layer was 18 μm. Al was sputtered on the positive electrode layer and an Al positive electrode collector was attached.

On the other surface, a slurry formed by dissolving a copolymer of polyethylene oxide and polypropylene oxide with addition of LiTFSI (lithium bistrifluoromethane sulfonylimide) as an Li salt in an ethanol solution was thinly coated and then dried, on which an Li metal foil of 0.1 mm thickness was bonded thereon to form a negative electrode. A secondary lithium ion battery was assembled by sealing the battery into a metal coin cell.

When the assembled secondary lithium ion battery was subjected to constant current charge/discharge measurement at a charge cut off voltage of 4.2V and a discharge cut off voltage of 2.7V, it could be confirmed that the battery could be driven at an average discharge voltage 4V and could be used under repetitive charge/discharge.

### Comparative Example 11

Using the solid electrolyte obtained in Comparative Example 3, and using same positive electrode and negative electrode as those in Example 11, a secondary lithium ion battery was assembled also by the identical manufacturing method.

When the assembled secondary lithium ion battery was put to charge/discharge measurement identical with that in Example 11, it reached 4.2V of charge cut off voltage in a short time. While discharge was conducted subsequently, no stable discharge potential could be obtained, the discharge cut off voltage was reached in a short time, and only about 20% of the capacity obtained in Example 10 could be measured. This is because no sufficient current could be supplied since the resistance of the electrolyte was high (ion conductivity was low).

### Example 12

Dried LiTFSI was charged by 1000 mg as a moisture absorbent in a 20 ml glass sample bottle, caped with a sintered material obtained in Example 3, and a gap was sealed by an epoxy type adhesive to form an evaluation sample for water permeability. When the sample was placed in a temperature stable and humidity stable chamber at a temperature of 60° C. and a humidity of 90% RH and maintained for 72 hours, and then the weight of LiTFSI was measured, it was 1010.2 mg. Weight increased by the moisture absorption corresponds to the water permeability of the sintered material, and the water permeable amount was 10.2 mg in this measurement.

### [Comparative Example 12

When measurement for the water permeability amount was conducted by using the sintered material obtained in Comparative Example 3 in the same method as in Example 12, the water permeable amount was 370 mg and it could be confirmed that the sintered material allowed to permeate much more water content compared with Example 12.

As described above, upon obtaining a solid electrolyte by sintering a lithium ion conductive inorganic powder, a solid electrolyte of higher density with low porosity and having good ion conductivity could be obtained by conducting sintering after pressing to densify by utilizing, for example, CIP.

Further, the thus obtained solid electrolyte can be used also as the electrolyte for the primary lithium battery or secondary lithium ion battery, and the battery using the solid electrolyte can attain a battery having a high battery capacity and usable stably for a long time.

Since the solid electrolyte of the invention formed by sintering after pressing or sintering while pressing a lithium ion conductive inorganic powder has a high lithium ion conductivity and is stable electrochemically, it is applicable not only as the electrolyte for use in a primary lithium battery or secondary lithium ion battery but also to an electrochemical capacitor referred to as a hybrid capacitor, a dye-sensitized solar battery and other electrochemical devices using lithium ions as a charge transporting support.

Several examples of other electrochemical devices are to be shown below.

By attaching an optional sensitive electrode on the electrolyte, it can be applied to various gas sensors or detectors. For example, it can be applied to a carbon dioxide gas sensor using a carbonate as an electrode, an Noₓ sensor using an electrode containing nitrate salt, and an SOₓ sensor using an electrode containing sulfate salt. Further, when assembling an electrolyte cell, it is applicable also to an electrolyte for use in decomposing or collecting apparatus for NOₓ, SOₓ, etc. contained in exhaust gases.

An electrochromic device can be constituted by attaching an inorganic compound or an organic compound that is colored or discolored by Li ion intercalation and disintercalation on an electrolyte and attaching thereon a transparent electrode such as of ITO, and an electrochromic display with less power consumption and having memory property can be provided.

Since the ion conduction channels of the solid electrolyte of the invention is in a size optimal to lithium ions, lithium ions can selectively pass even in a case where other alkali ions are present. Accordingly, it can be used as a diaphragm of a selective lithium ion collecting device, or a diaphragm for use a selective Li ion electrode. Further, since the velocity of permeating lithium ions is higher as the mass of the ion is smaller, it is applicable to isotope separation of lithium ions. This enables concentration and separation of concentrated 6 Li (7.42% by natural existence ratio) necessary for a tritium forming blanket material of a thermonuclear reactor fuels.

What is claimed is:

1. A lithium ion conductive solid electrolyte formed by sintering a molding product containing an inorganic powder and having a porosity of 10 vol % or less.

2. A lithium ion conductive solid electrolyte according to claim 1, wherein a composition containing the inorganic powder is press molded and then sintered.

3. A lithium ion conductive solid electrolyte according to claim 1, wherein the molding product is sintered under pressing.

4. A lithium ion conductive solid electrolyte according to any one of claims 1 to 3, wherein the inorganic powder contains 10 vol % or less of particles of 50 μm or more.

5. A lithium ion conductive solid electrolyte according to claim 4, wherein the maximum particle size of the inorganic powder is 15 times or less of the average particle size.

6. A lithium ion conductive solid electrolyte according to claim 4, wherein the average particle size of the inorganic powder is 2 μm or less.

7. A lithium ion conductive solid electrolyte according to claim 4, wherein the lithium ion conductivity of the inorganic powder is 1×10⁻⁷ Scm⁻¹ or higher at 25° C.

8. A lithium ion conductive solid electrolyte according to claim 4, wherein the inorganic powder contains lithium, silicon, phosphorus, or titanium.

9. A lithium ion conductive solid electrolyte according to claim 4, wherein the inorganic powder contains crystals of Li_{1+x+y}(Al, Ga)ₓ(Ti, Ge)₂₋ₓSi_{y}P_{3-y}O₁₂ in which 0≦x≦1 and 0≦y≦1.

10. A lithium ion conductive solid electrolyte according to claim 9, wherein 50 wt % or more of crystals are contained in the inorganic powder.

11. A lithium ion conductive solid electrolyte according to claim 9 , wherein the crystals are crystals not containing pores or crystal grain boundaries that hinder the ion conduction.

12. A lithium ion conductive solid electrolyte according to claim 4, wherein the inorganic powder is glass ceramics.

13. A lithium ion conductive solid electrolyte according to claim 9, wherein the lithium ion conductive crystals are contained by 50 wt % or more.

14. A lithium ion conductive solid electrolyte according to claim 12, wherein the lithium ion conductive glass ceramics are contained by 80 wt % or more.

15. A lithium ion conductive solid electrolyte according to claim 12, wherein the solid electrolyte contains glass ceramics comprising each of the ingredients, by mol % expression;
Li₂O: 12 to 18%,
Al₂O₃+Ga₂O₃: 5 to 10%,
TiO₂+GeO₂: 35 to 45%,
SiO₂: 1 to 10%, and
P₂O₅: 30 to 40%.

16. A lithium ion conductive solid electrolyte according to claim 4, wherein the inorganic powder is glass.

17. A lithium ion conductive solid electrolyte according to claim 4, wherein the lithium ion conductivity is 1×10⁻⁴ Scm⁻¹ or higher at 25° C.

18. A primary lithium battery having a lithium ion conductive solid electrolyte according to claim 4.

19. A secondary lithium ion battery having a lithium ion conductive solid electrolyte according to claim 4.

20. A process for producing a lithium ion conductive solid electrolyte of preparing a molding product using an inorganic powder as a main ingredient, and pressing and then sintering the molding product.

21. A process for producing a lithium ion conductive solid electrolyte of preparing a molding product using an inorganic powder as a main ingredient and sintering the same while pressing.

22. A process for producing a lithium ion conductive solid electrolyte according to claim 20 or 21, wherein the inorganic powder contains 10 vol % or less of particles of 50 μm or larger.

23. A process for producing a lithium ion conductive solid electrolyte according to claim 22, wherein the maximum particle size of the inorganic powder is 15 times or less of the average particle size.

24. A process for producing a lithium ion conductive solid electrolyte according to claim 22, wherein the average particle size of the inorganic power is 2 μm or less.

25. A process for producing a lithium ion conductive solid electrolyte according to claim 22, wherein the lithium ion conductivity of the inorganic powder is 1×10⁻⁷ Scm⁻¹ or higher at 25° C.

26. A process for producing a lithium ion conductive solid electrolyte according to claim 22, wherein the inorganic powder contains Li_{1+x+y}(Al, Ga)ₓ(Ti, Ge)₂₋ₓSi_{y}P_{3-y}O₁₂ in which 0≦x≦1 and 0≦y≦1.

27. A process for producing a lithium ion conductive solid electrolyte according to claim 26, wherein the crystal is a crystal not containing pores or crystal grain boundaries that hinder the ion conduction.

28. A process for producing a lithium ion conductive solid electrolyte according to claim 22, wherein the inorganic powder is glass ceramics.

29. A process for producing a lithium ion conductive solid electrolyte according to claim 22, wherein the inorganic powder is glass.

30. A process for producing a lithium ion conductive solid electrolyte according to claim 22, wherein the porosity of the molding product before sintering is 60% or less.
